(19) United States
(12) Patent Application Publication
(10) Pub. No.: US 2009/0267564 A1
(43) Pub. Date: Oct. 29, 2009

(54) Charging cabinet assembly for hand held devices

(76) Inventor: Martin Gerber, Brick, NJ (US)

Correspondence Address: CLIFFORD G. FRAYNE, 136 DRUM POINT RD, SUITE 7A, BRICK, NJ, 08723, US

(21) Appl. No.: 12/381,481

(22) Filed: Mar. 13, 2009

Related U.S. Application Data
(60) Provisional application No. 61/125,632, filed on Apr. 28, 2008.

(51) Int. Cl. H02J 7/00

(52) U.S. Cl. 320/114; 320/111

(57) ABSTRACT

A charging cabinet for hand held devices comprising a cavity defined by a rear wall, top and bottom parallel walls, and opposing side walls, and a front wall hingeably secured to one of the side walls to form a closure door, there being positioned within the cavity of the cabinet, a plurality of shelves for support of a hand held devices, the cabinet having a plurality of 110 volt or 220 volt outlets secured thereto, each of the 110 volt or 220 volt charging outlets having an on/off switch associated therewith to activate and deactivate a particular outlet, there also being a plurality of securing means associated with each shelf for securing excess wire associated with each charger in a compact manner, the charging cabinet being wall mounted or recessed in a wall and connected to a power source.

### RELATED APPLICATIONS

Applicant claims the benefit of provision application Ser. No. 61/125,632, filed Apr. 28, 2008.

### BACKGROUND OF THE INVENTION

1. Field of the Invention

The present invention relates to a cabinet assembly having a plurality of shelves and a plurality of electrical outlets which allows for hand held devices to be recharged at a centralized location thereby allowing free use of the wall outlets in a home or office.

2. Description of the Prior Art

The use of hand held devices has become very prevalent in our society. An individual may carry a cell phone, pager, IPOD, or MP3 player, or a combination of same. In a household with children, each member of the family may have their own individual cell phone, the children may also carry an IPOD or MP3 player, and the husband may carry a pager in addition to a cell phone.

All of these devices carry a charge for a certain amount of time and then must be recharged. The charge requires a 110 volt access (U.S.; 220 volts elsewhere) and the chargers themselves are normally unique to the particular hand-held device, and not interchangeable with other hand held devices. Therefore each charger must be plugged into a 110 volt outlet in the home or office and attached to the particular hand held device for recharging. In a home with two adults and two children, this could occupy half a dozen to a dozen outlets within the home at any given time, thereby denying access to those outlets for other electrical devices utilized in the home.

Still further, it is aesthetically unpleasing to see multiple hand held devices plugged into 110 volt wall outlets around the home. Still further, it is oftentimes the case that the individual will remove the hand held device from the recharger once charging has been accomplished, but leave the charging device plugged into the 110 volt wall outlet until another charging is required. This again presents an aesthetically unpleasing sight. Also, many of the charging units when left plugged into a 110 volt wall outlet will be drawing power, even though they are not attached to their particular hand held device for charging. This wastes energy.

Applicant's device is a centralized charging cabinet having an access door and multiple shelves and multiple 110 volt charging outlets (220 volts in some foreign countries) contained therein, such that multiple hand held devices can be recharged without interfering with the 110 volt wall outlets within-the home or office. The hand held devices can be recharged at a centralized location and with a closure member in the form of a door to the cabinet, do not present an aesthetically unpleasing sight.

### OBJECTS OF THE INVENTION

An object of the present invention is to provide for a centralized charging cabinet for hand held devices which allows for the recharging of multiple hand held devices without interfering with multiple 110 volt or 220 volt wall outlets within a home or office.

A further object of the present invention is to provide for a novel charging cabinet for hand held devices in which each of the 110 volt or 220 volt charging outlets within the cabinet have an on/off switch which allows the individual to leave the charger secured to the outlet, but interrupt power to the outlet when not in a charging mode so as to selectively disable the outlet.

A still further object of the present invention is to provide for a novel charging cabinet for hand held devices which includes multiple shelves for positioning the hand held devices and which provides for multiple securing means for securing the excess cord of the charging device in a neat and compact manner.

A still further object of the present invention is to provide for a novel charging cabinet for hand held devices which can be wall mounted and secured to a single 110 volt wall outlet or be hard wired.

A still further object of the present invention is to provide for a novel charging cabinet for hand held devices which would be recessed within a wall and hard wired for electrical power.

### SUMMARY OF THE INVENTION

A charging cabinet for hand held devices comprising a cavity defined by a rear wall, top and bottom parallel walls, and opposing side walls, and a front wall hingeably secured to one of the side walls to form a closure door, there being positioned within the cavity of the cabinet, a plurality of shelves for support of a hand held devices, the cabinet having a plurality of 110 volt or 220 volt outlets secured thereto, each of the 110 volt or 220 volt charging outlets having an on/off switch associated therewith to activate and deactivate a particular outlet, there also being a plurality of securing means associated with each shelf for securing excess wire associated with each charger in a compact manner, the charging cabinet being wall mounted or recessed in a wall and connected to a power source.

### BRIEF DESCRIPTION OF THE DRAWINGS

These and other objects of the present invention will become apparent, particularly when taken in light of the following illustrations wherein:

FIG. 1 is a front view of the charging cabinet of the present invention;

FIG. 2 is a cross sectional view along Plane 2-2 of FIG. 1;

FIG. 3 is a perspective view of the charging cabinet of the present invention mounted to the surface of a wall;

FIG. 4 is a perspective view of the charging cabinet of the present invention illustrating a recessed mount within the wall; and

FIG. 5 is a cross sectional view of FIG. 4 along Plane 5-5 illustrating an alternative arrangement of charging outlets for a recessed panel.

### DETAILED DESCRIPTION OF THE INVENTION

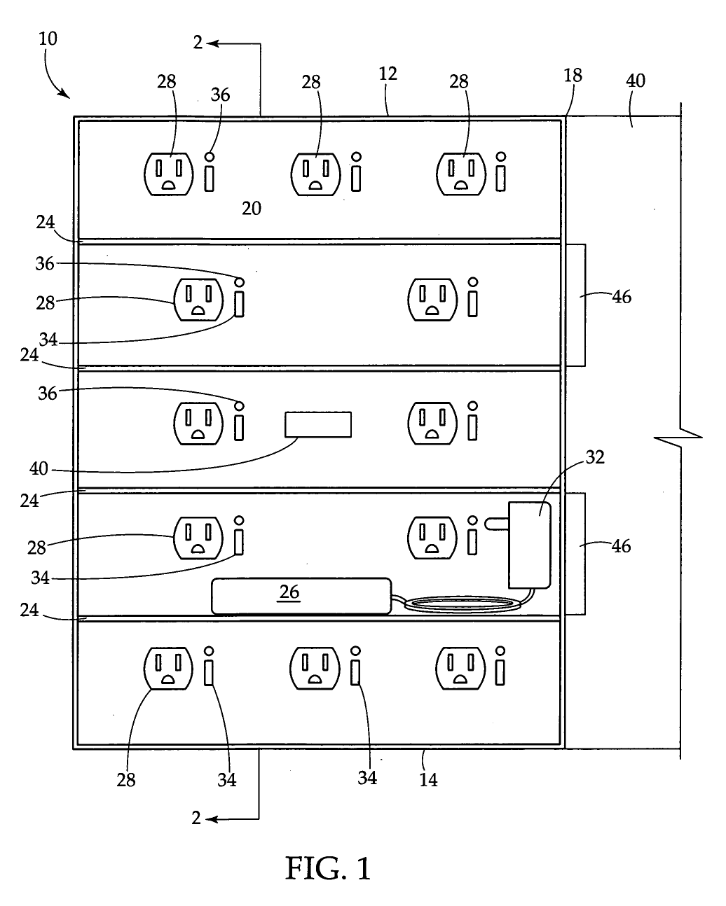

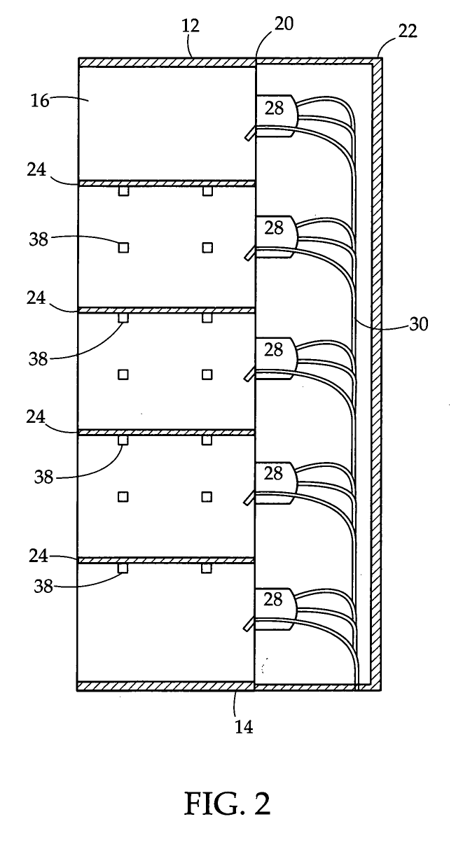

FIG. 1 is a front view of a charging cabinet 10 of the present invention, and FIG. 2 is a side cutaway view along Plane 2-2 of FIG. 1. It will be described with reference to 110 volt outlets, but it will be understood that the outlet voltage may differ depending upon the country of use.

The charging cabinet is formed of a top wall 12, a bottom wall 14, and two parallel side walls 16 and 18. The charging cabinet is formed with a first rear wall 20 and a second rear wall 22.

The area defined by top wall 12, bottom wall 14, parallel side walls 16 and 18 and first rear wall 20 is divided by adjustable horizontal shelves 24 which are designed to receive and support hand held devices 26 for recharging when not in use.

The space defined by top wall 12, bottom wall 14, parallel side walls 16 and 18, first rear wall 20 and second rear wall 22 defines the area in which multiple 110 volt outlets 28 are secured to first rear wall 20 and are electrically connected 30 to a power source as defined more fully hereafter. The 110 volt outlets 28 would be standard three prong grounded outlets, and would be spaced apart enough to allow multiple hand held devices 26 to be positioned and supported on the shelf 24 immediately below the outlets 28 and allow sufficient room for the transformer member 32 associated with each hand held device to be installed in a respective outlet 28.

The majority of transformers 32 associated with hand held devices 26 draw power when plugged into a 110 volt outlet 28 even if the transformer 32 is not connected to the particular hand held device 26. Individuals habitually leave the transformer member 32 plugged into the outlet once the hand held device is charged so that when it requires recharging, the individual merely plugs in the connector to the hand held device 26, the transformer member 28 already being secured in the outlet. Therefore, the preferred embodiment of the charging cabinet 10 of the present invention would have an on/off switch 34 associated with each 110 volt outlet 26. The on/off switch 34 could be a toggle switch or a push button style on/off switch which would selectively disrupt power to its assigned 110 volt outlet 28 when a hand held device 26 was not being charged. This toggle switch or push type on/off switch could be backlit in the on position to indicate to the individual that the particular outlet 28 was hot or had electrical energy available. If the toggle switch or push type on/off switch where not backlit, it could be connected to a small LED 36 which would signal to the individual as to the status of the particular electrical outlet 28. This would allow the individual to leave the transformer 32 connected to the 110 volt outlet when not recharging a hand held device, but to disrupt the power to that outlet 26 in order to conserve energy.

The shelves 24 in the preferred embodiment would be adjustable by means of a plurality of inwardly extending fingers 38 formed on the interior surface of the parallel side walls 14 and 16. This would allow the user to accommodate and recharge a hand held device which was too large to be accommodated on the shelves as depicted in FIG. 1. Still further, shelves 24 are removable and first rear wall 20 may be slidably removable to allow access to the outlet wiring.

A securing means in the form of a biased clip or the like 40 formed on the first back wall 20 or on the upper surface of a shelf 24 which would allow the individual to fold or wrap the excess cord associated with the transformer member 32 into a compact bundle.

The charging cabinet 10 may also be formed with an optional door 40 mounted on hinges 42 to one of the side walls 14 or 16 of the charging cabinet.

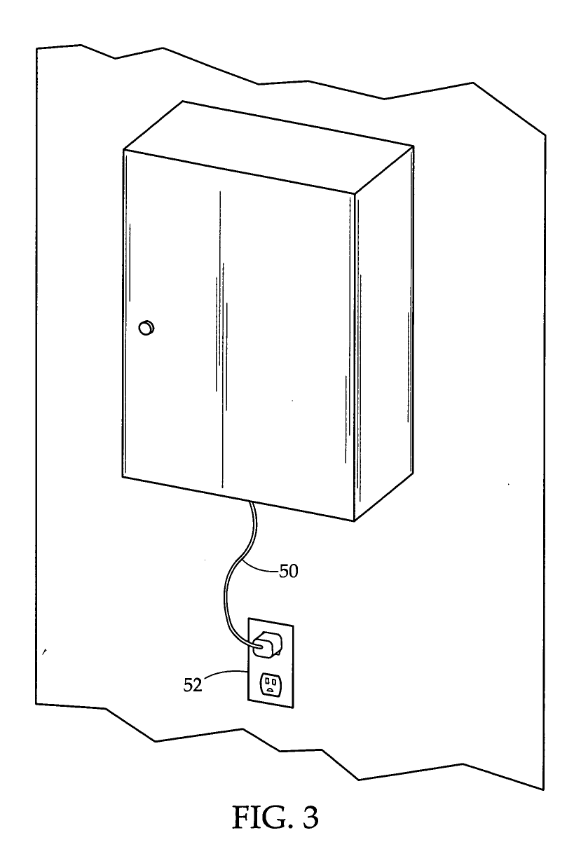

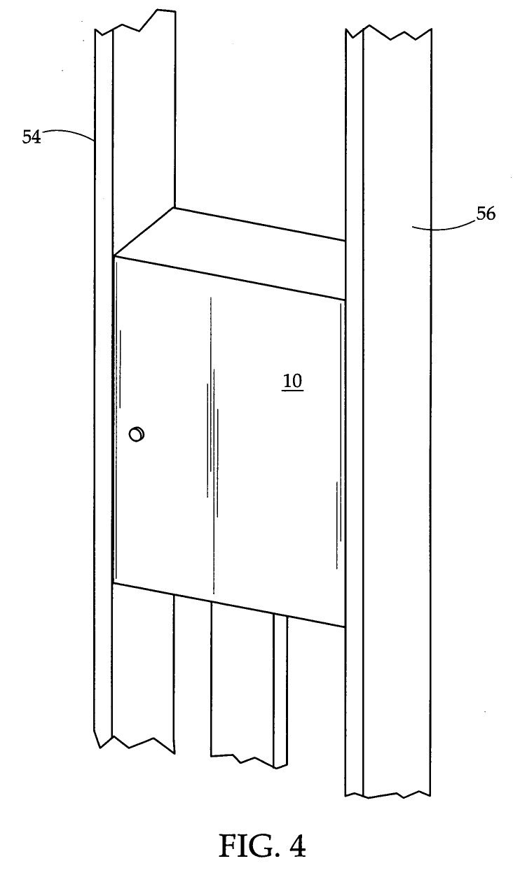

FIG. 3 is a perspective view of the charging cabinet 10 of the present invention mounted to a wall surface, and FIG. 4 is a perspective view of a charging cabinet recessed within a wall. The majority of hand held devices such as cell phones, MP3 players, IPODs and pagers average approximately 2 inches in width and 3 inches in length and the thickness is usually 1 inch or less. Therefore the charging cabinet as illustrated in FIG. 3 for attachment to a wall surface, while it can be any size, does not have to be overly large in order to accommodate a plurality of hand held devices. A depth of between 4 and 5 inches would allow sufficient space between first back wall 20 and second back wall 22 to accommodate the necessary 110 volt outlets, the switches, and the necessary wiring. This would leave a shelf space of between 3 and 4 inches in width to accommodate the hand held devices. Such a wall mounted charging cabinet could be mounted in a closet or cupboard or on a wall surface where its presence would not detract aesthetically from the room.

The wall mounted charging cabinet 10 could be powered by an exterior power cord 50 connected to a wall outlet 52, or it could be hard wired within the wall. FIG. 4 illustrates a charging cabinet 10 recessed in the wall and mounted between two adjacent studs 54 and 56. In this type of installation, the width of the charging cabinet 10 would normally be limited by the standardized distance between studs 54 and 56 as mandated by the building codes, and thus its width would be limited to 14½ inches. Its height would only be limited by any cross beams utilized in construction. If the front face or door closure member 40 were to be flush with the wall board or wall covering which sheaths the constructions studs 54 and 56, the charging cabinet would have a depth of approximately 4 inches which would be sufficient to allow for a 3 inch shelf and a 1 inch void space to accommodate the installation of the 110 volt wall outlets between first back wall 20 and second back wall 22. The recessed charging cabinet 10 as illustrated in FIG. 4 could be installed in a closet, cupboard, or on an interior wall of the house or office where its presence would not detract from the aesthetics of the room.

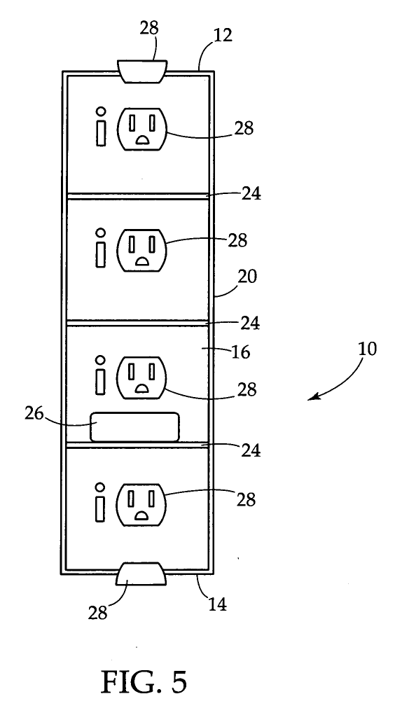

FIG. 5 is a cross sectional view of the cabinet assembly along Plane 5-5 of FIG. 4. FIG. 4 illustrated a cabinet assembly of the present invention which was fully recessed within a wall. FIG. 5 illustrates an alternative embodiment of the cabinet assembly when fully recessed if the thickness of the wall is such that it does not allow the embodiment as illustrated in FIGS. 1 and 2. Still further, the embodiment illustrated in FIG. 5 offers an alternative embodiment if the recessed cabinet assembly is installed during new construction, and the framing of the wall allows the configuration.

The charging cabinet 10 is identical to the embodiments previously described having a top wall 12, bottom wall 14, two parallel side walls 16 and 18, and only one rear wall 20. Horizontal shelves 24 are adjusted disposed within the cabinet to support the hand held devices 26 for recharging. The difference in the embodiment illustrated in FIG. 3 is that the multiple 110 volt outlets 28 are now disposed through the sidewalls 16 and 18, and the top wall and bottom wall 12 and 14 to reduce the depth of the cabinet.

Locating the 110 volt outlets 28 on the top wall 12 and bottom wall 14 would still allow the recessed cabinet to be positioned between the standard distance of two parallel adjacent wall studs. However, if the charging cabinet assembly 10 is being installed in new construction, the depth of the cabinet can be reduced and the number of multiple 110 volt outlets 28 increased by positioning these outlets on side walls 16 and 18 by adjusting the distance of adjacent wall studs and the framing so as to accommodate the cabinet in a fully recessed mode. The wiring, hookups and closure of the charging cabinet embodiment illustrated in FIG. 5 would remain the same as that previously discussed.

FIGS. 1 and 2 illustrate a charging cabinet 10 having four adjustable shelves and one fixed shelf, bottom wall 14, as well as odd numbered and even numbered wall outlets 28 associated with each shelf 24. This depiction is for illustrative purposes only. The number of shelves and the number of outlets may vary with the determining factor being the number of hand held devices utilized by the individual or the members of the household or the members of an office staff.

Therefore, while the present invention has been disclosed with respect to the preferred embodiments thereof, it will be recognized by those of ordinary skill in the art that various changes and modifications can be made without departing from the spirit and scope of the invention. It is therefore manifestly intended that the invention be limited only by the claims and the equivalence thereof.

I claim:

1. A charging cabinet for hand held devices, such as cell phones and personal digital assistants, said charging cabinet defined by a rear wall, top and bottom parallel walls, and opposing parallel side walls, and a front wall hingeably secured to one of said side walls to form a closure door, thereby defining a cavity, said cavity formed with a plurality of shelves for support of said hand held devices, the charging cabinet having a plurality of charging outlets accessible in said cavity, each of said charging outlets having associated therewith, a plurality of securing means associated with each charging outlet for securing excess wire associated with a charger for each of said hand held devices.

2. The charging cabinet in accordance with claim 1 wherein each of said charging outlets are also formed with an on/off switch so as to activate and deactivate said particular charging outlet so as to charge a hand held device when in use and deactivate the charging outlet when not in use.

3. The charging cabinet in accordance with claim 1 wherein each of said plurality of shelves are adjustable in height to accommodate said hand held devices of varying sizes.

4. The charging cabinet in accordance with claim 1 wherein said charging cabinet is wall mounted.

5. The charging cabinet in accordance with claim 1 wherein said charging cabinet is recessed in a wall.

6. The charging cabinet in accordance with claim 1 wherein said charging outlets are secured in said sidewalls of said charging cabinet.

7. The charging cabinet in accordance with claim 1 wherein said charging outlets are secured in said top and bottom walls of said charging cabinet.

8. The charging cabinet in accordance with claim 1 wherein said charging outlets are secured in said rear wall of said charging cabinet.

9. The charging cabinet in accordance with claim 1 wherein the charging outlets are 110 volt.

10. The charging cabinet in accordance with claim 1 wherein the charging outlets are 220 volts.
